(19) United States
(12) Patent Application Publication
(10) Pub. No.: US 2012/0016568 A1
(43) Pub. Date: Jan. 19, 2012

(54) COMBUSTION STATE DETECTION SYSTEM AND COMBUSTION STATE DETECTION METHOD FOR INTERNAL COMBUSTION ENGINE

(75) Inventors: Shuntaro Okazaki, Sunto-gun (JP); Akihiro Katayama, Toyota-shi (JP); Masanori Ishida, Susono-shi (JP); Yuki Ikejiri, Toyota-shi (JP)

(73) Assignee: TOYOTA JIDOSHA KABUSHIKI KAISHA, Toyota-shi (JP)

(21) Appl. No.: 13/181,489

(22) Filed: Jul. 12, 2011

(30) Foreign Application Priority Data
Jul. 15, 2010 (JP) 2010-160944

(51) Int. Cl. F02D 28/00; F02D 41/00

(52) U.S. Cl. 701/103; 701/102

(57) ABSTRACT

Detecting a combustion state of an internal combustion engine includes calculating a one-step difference value and a two-step difference value of a physical quantity that correlates with torque generated by the internal combustion engine; detecting that a misfire has occurred, when the calculated one-step difference value is greater than a first determining value, and the calculated two-step difference value is greater than a second determining value; and determining the first determining value and the second determining value according to a required torque of the internal combustion engine, sensitivity of a change in the one-step difference value with respect to a change in the required torque, and sensitivity of a change in the two-step difference value with respect to a change in the required torque.

### CROSS-REFERENCE TO RELΔTED APPLICATIONS

This application claims priority to Japanese Patent Application No. 2010-160944 filed on Jul. 15, 2010 which is incorporated herein by reference in its entirety including the specification, drawings and abstract.

### BACKGROUND OF THE INVENTION

1. Field of the Invention

The invention relates to technology for detecting the combustion state of an internal combustion engine.

2. Description of Related Art

Japanese Patent Application Publication No. 07-217488 (JP-A-07-217488), for example, describes technology that determines that a misfire has occurred by comparing a two-step difference value of an engine speed with a determining value, as technology that determines deterioration of a combustion state (i.e., a misfire) of an internal combustion engine.

Incidentally, when the required torque of an internal combustion engine is small, as is the case when the internal combustion engine is operating under a low load, the two-step difference value of the engine speed is low. Therefore, the two-step difference value may be lower than the determining value even if a misfire is occurring.

### SUMMARY OF THE INVENTION

The invention provides a combustion state detection system, and a combustion state detection method, for an internal combustion engine, that detects deterioration of a combustion state based on a parameter that correlates with torque generated by the internal combustion engine, and that more accurately detects deterioration of the combustion state even if torque fluctuation due to deterioration of the combustion state is small.

According to first and second aspects of the invention, in a combustion state detecting system and a combustion state detecting method that detect deterioration of the combustion state (i.e., a misfire) by comparing a one-step difference value and a two-step difference value of a parameter that correlates with torque generated by an internal combustion engine with individually set determining values, each of these determining values is determined according to the sensitivity of the one-step difference value with respect to the torque generated by the internal combustion engine and the sensitivity of the two-step difference value with respect to the torque generated by the internal combustion engine.

More specifically, the first aspect of the invention relates to a combustion state detection system for an internal combustion engine. This combustion state detection system includes a calculating portion that calculates a one-step difference value and a two-step difference value of a physical quantity that correlates with torque generated by the internal combustion engine; a detecting portion that detects that a misfire has occurred, when the one-step difference value calculated by the calculating portion is greater than a first determining value, and the two-step difference value calculated by the calculating portion is greater than a second determining value; and a determining portion that determines the first determining value and the second determining value according to a required torque of the internal combustion engine, sensitivity of a change in the one-step difference value with respect to a change in the required torque, and sensitivity of a change in the two-step difference value with respect to a change in the required torque.

The second aspect of the invention relates to a combustion state detection method for an internal combustion engine. This combustion state detection method includes calculating a one-step difference value and a two-step difference value of a physical quantity that correlates with torque generated by the internal combustion engine; detecting that a misfire has occurred, when the calculated one-step difference value is greater than a first determining value, and the calculated two-step difference value is greater than a second determining value; and determining the first determining value and the second determining value according to a required torque of the internal combustion engine, sensitivity of a change in the one-step difference value with respect to a change in the required torque, and sensitivity of a change in the two-step difference value with respect to a change in the required torque.

The first determining value here is the maximum value that the one-step difference value can be during normal combustion when a misfire is not occurring, or a value obtained by adding a predetermined margin to that maximum value. Also, the second determining value is the maximum value that the two-step difference value can be during normal combustion, or a value obtained by adding a predetermined margin to that maximum value.

Incidentally, the maximum values that the one-step difference value and the two-step difference value can be during normal combustion change according to the required torque of the internal combustion engine (i.e., the torque generated in cylinders that are not misfiring). Moreover, the change sensitivity of the one-step difference value with respect to the change in the required torque is not the same as the change sensitivity of the two-step difference value with respect to the change in the required torque. For example, the ratio of a change in the two-step difference value to a change in the required torque tends to be larger than the ratio of a change in the one-step difference value to a change in the required torque. That is, the sensitivity of the two-step difference value with respect to a change in the required torque is higher than the sensitivity of the one-step difference level with respect to a change in the required torque.

Therefore, in the combustion state detection in an internal combustion engine of the first and second aspects of the invention, the first determining value and the second determining value are determined according to the change sensitivity of the one-step difference value with respect to the required torque and the change sensitivity of the two-step difference value with respect to the required torque. Accordingly, it is possible to prevent the two-step difference value from becoming equal to or less than the second determining value when a misfire has occurred while the required torque is small, i.e., it is possible to prevent an erroneous determination (i.e., an erroneous detection) that a misfire is not occurring from being made even though a misfire is occurring.

The determining portion in the first aspect of the invention may determine the first determining value and the second determining value such that a relative difference between the first determining value and the second determining value increases as the required torque becomes smaller.

The maximum value (hereinafter referred to as the “first maximum value”) that the one-step difference value can be during normal combustion is smaller when the required torque is small than it is when the required torque is large. Similarly, the maximum value (hereinafter referred to as the “second maximum value”) that the two-step difference value can be during normal combustion is smaller when the required torque is small than it is when the required torque is large. However, the difference between when the required torque is large and when the required torque is small is larger with the second maximum value than it is with the first maximum value. That is, the relative difference between the first maximum value and the second maximum value is larger when the required torque is small than it is when the required torque is large.

Thus, the two-step difference value can be more reliably prevented from becoming equal to or less than the second determining value when a misfire occurs, by having the relative difference between the first determining value and the second determining value be larger when the required torque is small than it is when the required torque is large.

Also, when an ignition timing retarding process that retards an ignition timing of the internal combustion engine beyond MBT (Minimum spark advance for Best Torque) is being executed, the determining portion in the first aspect of the invention may determine the first determining value and the second determining value such that a relative difference between the first determining value and the second determining value increases as a retard amount of the ignition timing increases.

When the ignition timing retarding process is being executed, the difference between the torque generated during a misfire and the torque generated during normal combustion is smaller. The difference at this time is smaller when the retard amount of the ignition timing is large than it is when the retard amount of the ignition timing is small.

Thus, when the ignition timing retarding process is being executed, the two-step difference value can be more reliably prevented from becoming equal to or less than the second determining value even though a misfire is occurring, by having the relative difference between the first determining value and the second determining value be larger when the retard amount of the ignition timing is large than it is when the retard amount of the ignition timing is small.

When a richening process that makes a target air-fuel ratio lower than a stoichiometric air-fuel ratio is being executed, the determining portion in the first aspect of the invention may determine the first determining value and the second determining value such that a relative difference between the first determining value and the second determining value increases as the target air-fuel ratio decreases.

When the richening process is executed, the difference between the torque generated during a misfire and the torque generated during normal combustion is small. The difference at this time is smaller when the amount of decrease in the target air-fuel ratio is large than it is when the amount of decrease in the target air-fuel ratio is small.

Thus, when the richening process is being executed, the two-step difference value can be more reliably prevented from becoming equal to or less than the second determining value even though a misfire is occurring, by having the relative difference between the first determining value and the second determining value be larger when the amount of decrease in the target air-fuel ratio is large than it is when the amount of decrease in the target air-fuel ratio is small.

Incidentally, the physical quantity that correlates with the torque generated by the internal combustion engine in the first and second aspects of the invention may be the time that it takes for the crankshaft to rotate a certain amount during the expansion stroke, the rotation speed of the crankshaft during the expansion stroke or during a period of time of part of the expansion stroke, or the angular acceleration of the crankshaft during the expansion stroke or during a period of time of part of the expansion stroke or the like.

According to the first and second aspects of the invention, deterioration of the combustion state is able to be more reliably detected, even if torque fluctuation due to deterioration of the combustion state is small, in a system that detects deterioration of the combustion state based on a parameter that correlates with torque fluctuation in an internal combustion engine.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view of the general structure of an internal combustion engine according to a first example embodiment of the invention;

FIG. 2 is a graph showing the relationship between the required torque of the internal combustion engine and difference values (ΔT1, ΔT2) according to the first example embodiment of the invention;

FIG. 3 is a view showing a frame format of a map defining the relationship between the required torque of the internal combustion engine and determining values (ΔT1st, ΔT2st) according to the first example embodiment of the invention;

FIG. 4 is a flowchart illustrating a combustion state detection routine according to the first example embodiment of the invention;

FIG. 5 is a view showing a frame format of a map defining the relationship between the ignition timing and correction values (a1, a2) according to a second example embodiment of the invention;

FIG. 6 is a flowchart illustrating a combustion state detection routine according to the second example embodiment of the invention;

FIG. 7 is a view showing a frame format of a map defining the relationship between a target air-fuel ratio and correction values (a3, a4) according to a third example embodiment of the invention; and

FIG. 8 is a flowchart illustrating a combustion state detection routine according to the third example embodiment of the invention.

### DETAILED DESCRIPTION OF EMBODIMENTS

Next, specific example embodiments of the invention will be described with reference to the accompanying drawings. Unless otherwise specifically stated, the technical scope of the invention is not limited to the dimensions, materials, shapes, and relative arrangements and the like of constituent parts described in the example embodiments.

### First Example Embodiment

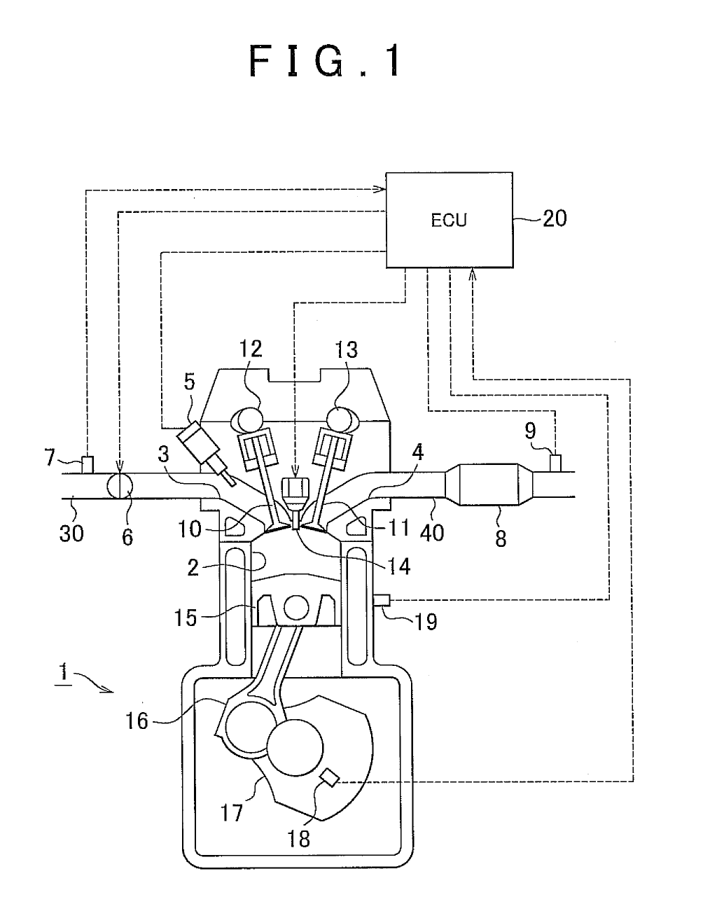

First, a first example embodiment of the invention will be described with reference to FIGS. 1 to 4. FIG. 1 is a view of the general structure of an internal combustion engine to which the invention is applied. The internal combustion engine 1 shown in FIG. 1 is a four-stroke cycle spark-ignition type internal combustion engine (a gasoline engine) having four cylinders. Incidentally, only one cylinder 2 of the four cylinders is shown in FIG. 1.

Each cylinder 2 of the internal combustion engine 1 is connected to an intake passage 30 via an intake port 3, and is also connected to an exhaust passage 40 via an exhaust port 4. A fuel injection valve 5 that injects fuel toward the inside of the cylinder 2 is provided in the intake port 3. A throttle valve 6 that controls the amount of air that flows through the intake passage 30 is provided in the intake passage 30. An airflow meter 7 that measures the amount of air that flows through the intake passage 30 is provided in the intake passage 30 upstream of the throttle valve 6.

An exhaust gas control apparatus 8 is arranged the exhaust passage 40. The exhaust gas control apparatus 8 includes a three-way catalyst or a NOx storage-reduction catalyst or the like, and purifies exhaust gas when in a predetermined activating temperature range. An air-fuel ratio sensor 9 that outputs an electric signal indicative of the air-fuel ratio (i.e., the amount of air/the amount of fuel) of the exhaust gas that flows through the exhaust passage 40 is arranged in the exhaust passage 40 downstream of the exhaust gas control apparatus 8.

Also, an intake valve 10 that opens and closes an open end of the intake port 3 facing into the cylinder 2, and an exhaust valve 11 that opens and closes and an open end of the exhaust port 4 facing into the cylinder 2 are provided in the internal combustion engine 1. The intake valve 10 is driven so as to be opened and closed by an intake side camshaft 12, and the exhaust valve 11 is driven so as to be opened and closed by an exhaust side camshaft 13.

A spark plug 14 that ignites an air-fuel mixture in the cylinder 2 is arranged at an upper portion of the cylinder 2. A piston 15 is slidably inserted in the cylinder 2, and is connected to a crankshaft 17 via a connecting rod 16.

A crank position sensor 18 that outputs an electric signal indicative of the rotational position of the crankshaft 17 is arranged in the internal combustion engine 1 near the crankshaft 17. In addition, a coolant temperature sensor 19 that measures the temperature of coolant circulating through the internal combustion engine 1 is mounted to the internal combustion engine 1.

An ECU 20 is also provided in the internal combustion engine 1 structured in this way. The ECU 20 is an electronic control unit that includes a CPU, ROM, and RAM and the like. The ECU 20 is electrically connected to various sensors, such as the airflow meter 7, the air-fuel ratio sensor 9, the crank position sensor 18, and the coolant temperature sensor 19 described above, and receives measurement values from these various sensors.

The ECU 20 electrically controls the fuel injection valve 5, the throttle valve 6, and the spark plug 14 based on the measurement values from the various sensors described above. For example, the ECU 20 performs a combustion state detection routine for detecting the combustion state of the internal combustion engine 1.

In this combustion state detection routine, the ECU 20 detects deterioration of the combustion state (i.e., a misfire) by comparing a one-step difference value and a two-step difference value of a parameter that correlates with torque generated by the internal combustion engine 1. The time that it takes for the crankshaft 17 to rotate a certain amount during the expansion stroke, the rotation speed of the crankshaft 17 during the expansion stroke or during a period of time of part of the expansion stroke, or the angular acceleration of the crankshaft during the expansion stroke or during a period of time of part of the expansion stroke or the like the may be used as the physical quantity (i.e., the parameter) that correlates with the torque generated by the internal combustion engine 1. In this example embodiment, the time T that it takes for the crankshaft 17 to rotate a certain angle from top dead center (TDC) of the expansion stroke will be used as this parameter.

The ECU 20 calculates, based on the output signal of the crank position sensor 18, the time (hereinafter referred to as “first predetermined time”) T(1) that it takes for the crankshaft 17 to rotate a certain angle from TDC of the expansion stroke in a given cylinder (hereinafter referred to as the “first cylinder”), and the time (hereinafter referred to as the “second predetermined time”) T(2) that it takes for the crankshaft 17 to rotate a certain angle from TDC of the expansion stroke in a cylinder having the next expansion stroke after the expansion stroke of the first cylinder (hereinafter this cylinder will be referred to as the “second cylinder”).

The ECU 20 also calculates the time (hereinafter referred to as the “third predetermined time”) T(3) that it takes for the crankshaft 17 to rotate a certain angle from TDC of the expansion stroke in a cylinder having an expansion stroke 360 degrees (CA (crank angle)) after the expansion stroke of the first cylinder (hereinafter this cylinder will be referred to as the “third cylinder”), and the time (hereinafter referred to as the “fourth predetermined time”) T(4) that it takes for the crankshaft 17 to rotate a certain angle from TDC of the expansion stroke in a cylinder having an expansion stroke 360 degrees (CA) after the expansion stroke of the second cylinder.

The ECU 20 then calculates a one-step difference value ΔT1 by subtracting the second predetermined time T(2) from the first predetermined time T(1). The ECU 20 also calculates a two-step difference value ΔT2 (={T(1)−T(2)}−{T(3)−T(4)}) by subtracting the difference between the third predetermined time T(3) and the fourth predetermined time T(4) (i.e., T(3)-T(4)) from the difference between the first predetermined time T(1) and the second predetermined time T(2) (i.e., T(1)-T(2)).

The ECU 20 then compares the one-step difference value ΔT1 with a first determining value ΔT1st, and compares the two-step difference value ΔT2 with a second determining value ΔT2st. Incidentally, the first determining value ΔT1st is the maximum value that the one-step difference value can be during normal combustion when a misfire is not occurring, or a value obtained by adding a predetermined margin to that maximum value. The second determining value ΔT2st is the maximum value that the two-step difference value can be during normal combustion, or a value obtained by adding a predetermined margin to that maximum value. The predetermined margins described above are values determined based on the measurement error of the crank position sensor 18, for example.

The ECU 20 determines that a misfire has occurred in the first cylinder when the one-step difference value ΔT1 is greater than the first determining value ΔT1st (i.e., ΔT1>ΔT1st), and the two-step difference value ΔT2 is greater than the second determining value ΔT2st (i.e., ΔT2>ΔT2st).

Incidentally, the maximum values that the one-step difference value ΔT1 and the two-step difference value ΔT2 can be during normal combustion change according to the required torque of the internal combustion engine 1 (i.e., according to the torque generated in cylinders that are not misfiring). At this time, the change sensitivity of the one-step difference value ΔT1 with respect to the change in the required torque is not the same as the change sensitivity of the two-step difference value ΔT2 with respect to the change in the required torque. That is, the amount of change in the one-step difference value ΔT1 with respect to the amount of change in the required torque is not the same as the amount of change in the two-step difference value ΔT2 with respect to the amount of change in the required torque.

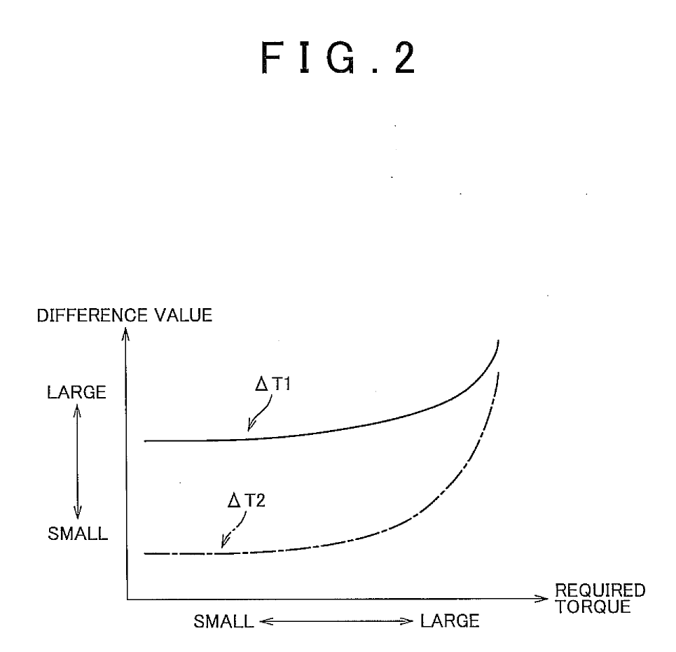

FIG. 2 is a graph showing the relationship between the required torque during normal combustion and the maximum values of the difference values ΔT1 and ΔT2. The solid line in FIG. 2 represents the maximum value (i.e., a first maximum value) of the one-step difference value ΔT1, and the alternate long and short dash line in FIG. 2 represents the maximum value (i.e., a second maximum value) of the two-step difference value ΔT2. As shown in FIG. 2, the maximum values of the difference values ΔT1 and ΔT2 are smaller when the required torque is small than they are when the required torque is large. However, the difference between when the required torque is small and when the required torque is large is greater with the second maximum value than it is with the first maximum value. That is, the relative difference between the first maximum value and the second maximum value is larger (i.e., the second maximum value becomes even smaller than the first maximum value) when the required torque is small than it is when the required torque is large. Accordingly, the change sensitivity of the two-step difference value ΔT2 with respect to the change in the required torque is higher than the change sensitivity of the one-step difference value ΔT1 with respect to the change in the required torque.

Here, if the first determining value and the second determining value are determined without taking this kind of change sensitivity into account, then when the required torque of the internal combustion engine 1 is small, it may erroneously be determined that a misfire is not occurring even though a misfire is occurring. That is, if a misfire occurs when the required torque of the internal combustion engine 1 is small, the value of the two-step difference value may become equal to or less than the second determining value.

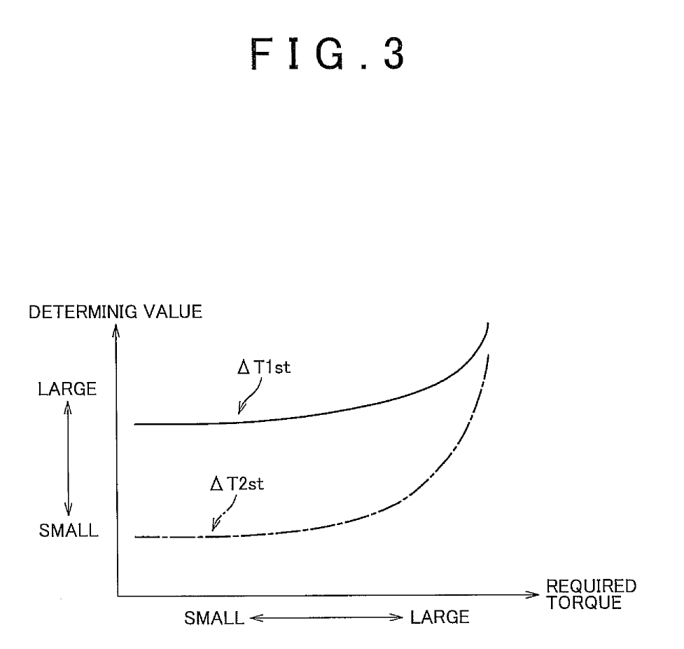

In contrast, in the combustion state detection routine according to this example embodiment, the ECU 20 determines the first determining value ΔT1st and the second determining value ΔT2st according to the change sensitivities of the one-step difference value ΔT1 and the two-step difference value ΔT2 with respect to the change in the required torque. More specifically, the ECU 20 determines the first determining value ΔT1st and the second determining value ΔT2st based on the required torque of the internal combustion engine 1 and the map shown in FIG. 3. FIG. 3 is a map defining the relationship between the required torque and the determining values ΔT1st and ΔT2st. The determining values ΔT1st and ΔT2st shown in FIG. 3 are obtained by adding a predetermined margin to the first maximum value and the second maximum value shown in FIG. 2 described above.

In this way, if the first determining value ΔT1st is determined according to the change sensitivity of the one-step difference value ΔT1 with respect to the change in the required torque and the second determining value ΔT2st is determined according to the change sensitivity of the two-step difference value ΔT2 with respect to the change in the required torque, then when the required torque of the internal combustion engine 1 is small, the second determining value ΔT2st will also be set to a small value accordingly. As a result, it is possible to prevent a situation in which the two-step difference value ΔT2 becomes equal to or less than the second determining value ΔT2st as a result of a misfire occurring when the required torque is small. Therefore, it is possible to prevent an erroneous determination that a misfire is not occurring from being made even though a misfire is occurring, when the required torque of the internal combustion engine 1 is small.

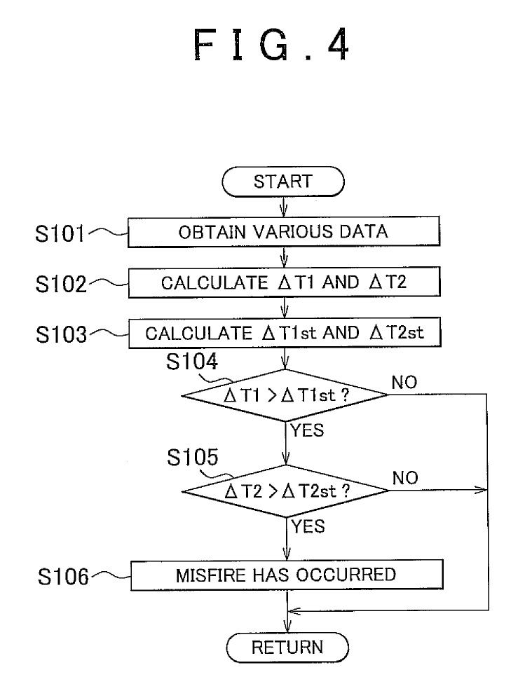

Hereinafter, the procedure for executing the combustion state detection routine of this example embodiment will be described with reference to FIG. 4. FIG. 4 is a flowchart illustrating the combustion state detection routine. This routine is a routine that is stored in the ROM of the ECU 20 beforehand, and is executed by the ECU 20 regularly (such as each time the rotational position of the crankshaft 17 matches TDC of the expansion stroke in each cylinder 2).

In the combustion state detection routine, the ECU 20 first obtains various data in step S101. For example, the ECU 20 calculates the required torque of the internal combustion engine 1 with the accelerator operation amount or the engine speed or the like as the parameter.

In step S102, the ECU 20 calculates the one-step difference value ΔT1 and the two-step difference value ΔT2. In this way, a calculating portion according to the invention is realized by the ECU 20 executing step S102.

In step S103, the ECU 20 calculates the first determining value ΔT1st and the second determining value ΔT2st from the required torque obtained in step S101 and the map in FIG. 3. In this way, a determining portion according to the invention is realized by the ECU 20 executing step S103.

In step S104, the ECU 20 determines whether the one-step difference value ΔT1 obtained in step S102 is greater than the first determining value ΔT1st obtained in step S103. If the determination in step S104 is no (i.e., if ΔT1 ΔT1st), the ECU 20 ends this cycle of the routine. If, on the other hand, the determination in step S104 is yes (i.e., if ΔT1 >ΔT1st), the ECU 20 proceeds on to step S105.

In step S105, the ECU 20 determines whether the two-step difference value ΔT2 obtained in step S102 is greater than the second determining value ΔT2st obtained in step S103. If the determination in step S105 is no (i.e., if ΔT2 ΔT2st), the ECU 20 ends this cycle of the routine. If, on the other hand, the determination in step S105 is yes (i.e., if ΔT2 >ΔT2st), the ECU 20 proceeds on to step S106, where it determines that a misfire has occurred in the internal combustion engine 1 (i.e., in the first cylinder).

Incidentally, a detecting portion according to the invention is realized by the ECU 20 executing steps S104 and S105.

According to the example embodiment described above, it is possible to more accurately determine (i.e., detect) that a misfire has occurred even if the torque fluctuation amount from the misfire is small.

### Second Example Embodiment

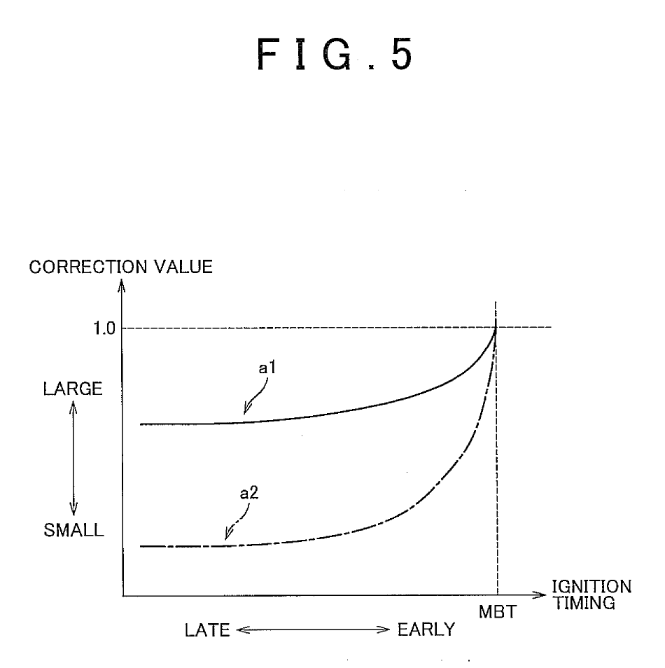

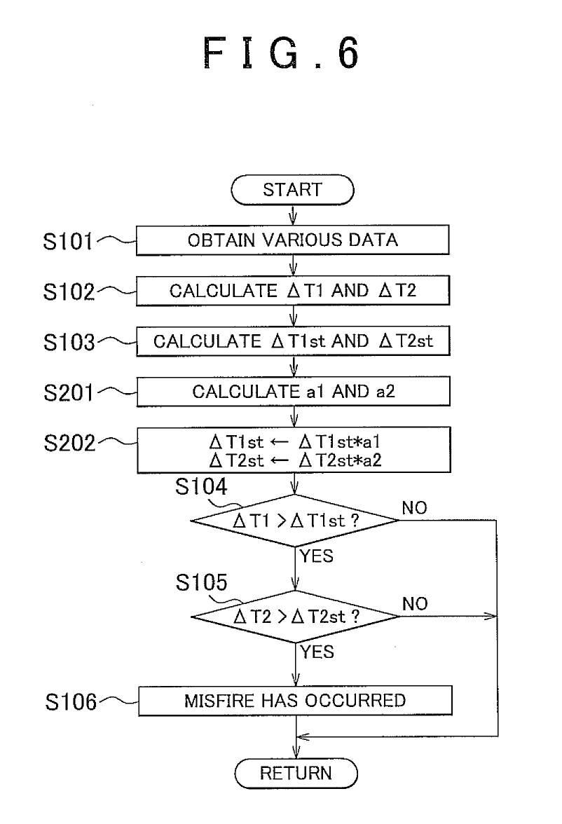

Next, a second example embodiment of the invention will be described with reference to FIGS. 5 and 6. Here, structure that differs from the structure of the first example embodiment described above will be described. Descriptions of like structure will be omitted.

The second example embodiment differs from the first example embodiment described above in that the determining values ΔT1st and ΔT2st are corrected according to a retard amount of the ignition timing, when an ignition timing retarding process that retards the operation timing (i.e., the ignition timing) of the spark plug 14 beyond MBT is executed.

When the ignition timing retarding process is executed, the difference between the torque generated during a misfire and the torque generated during normal combustion becomes smaller. The difference at this time is smaller when the retard amount of the ignition timing is large than it is when the retard amount of the ignition timing is small. Accordingly, the first determining value ΔT1st and the second determining value ΔT2st must be set to smaller values, and the relative difference between the first determining value ΔT1st and the second determining value ΔT2st must be increased, when the retard amount of the ignition timing is large compared to when it is small.

Therefore, with a combustion state detection routine according to the second example embodiment, the ECU 20 corrects the determining values ΔT1st and ΔT2st based on the retard amount of the ignition timing. The correction amount at this time is determined such that the relative difference between the first determining value and the second determining value is larger when the retard amount of the ignition timing is large than it is when the retard amount of the ignition timing is small.

FIG. 5 is a map defining the relationship between the ignition timing and correction values a1 and a2 of the determining values ΔT1st and ΔT2st, respectively. The solid line is FIG. 5 represents the correction value (hereinafter referred to as the “first correction value”) a1 of the first determining value ΔT1st, and the alternate long and short dash line in FIG. 5 represents the correction value (hereinafter referred to as the “second correction value”) a2 of the second determining value ΔT2st.

In FIG. 5, the first correction value a1 and the second correction value a2 are set to 1 when the ignition timing matches the MBT, and are set to positive numbers less than 1 when the ignition timing is later than MBT. Furthermore, when the ignition timing is later than MBT, the second correction value a2 is set to a smaller value than the first correction value a1 is. At this time, the relative difference between the first correction value a1 and the second correction value a2 is set to be greater when the ignition timing is late than it is when the ignition timing is early.

Next, the ECU 20 corrects the determining values ΔT1st and ΔT2st determined based on the required torque of the internal combustion engine 1 and the map in FIG. 3, with the correction values a1 and a2. More specifically, the ECU 20 multiplies the first determining value ΔT1st by the first correction value a1, and multiplies the second determining value ΔT2st by the second correction value a2.

Correcting the first determining value ΔT1st and the second determining value ΔT2st according to this kind of method enables a misfire to be more accurately detected even when an ignition timing retarding process is being executed.

Hereinafter, the procedure for executing the combustion state detection routine according to the second example embodiment will be described with reference to FIG. 6. FIG. 6 is a flowchart illustrating the combustion state detection routine. In FIG. 6, steps that are the same as those in the combustion state detection routine of the first example embodiment described above (see FIG. 4) will be denoted by the same step numbers.

This routine differs from the routine shown in FIG. 4 in that steps S201 and S202 are executed between steps S103 and S104. That is, the ECU 20 executes steps S201 and S202 after executing step S103.

In step S201, the ECU 20 calculates the first correction value a1 and the second correction value a2 based on a target ignition timing and the map shown in FIG. 5. The target ignition timing at this time may be a target ignition timing determined by the ECU 20 executing a separate ignition timing control routine.

In step S202, the ECU 20 corrects the determining values ΔT1st and ΔT2st calculated in step S103, with the correction values a1 and a2 calculated in step S201. That is, the ECU 20 multiplies the first determining value ΔT1st by the first correction value a1, and multiplies the second determining value ΔT2st by the second correction value a2.

Steps S104 and S105 that follow are executed using the determining values ΔT1st and ΔT2st corrected in step S202.

According to the example embodiment described above, a misfire can be more accurately determined (i.e., detected) even when an ignition timing retarding process is being executed, in addition to when the required torque of the internal combustion engine 1 is small.

### Third Example Embodiment

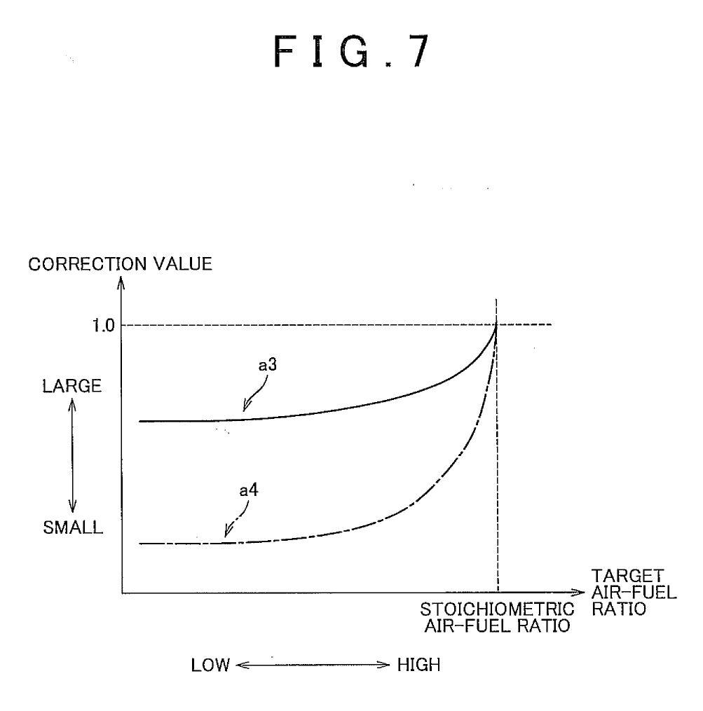

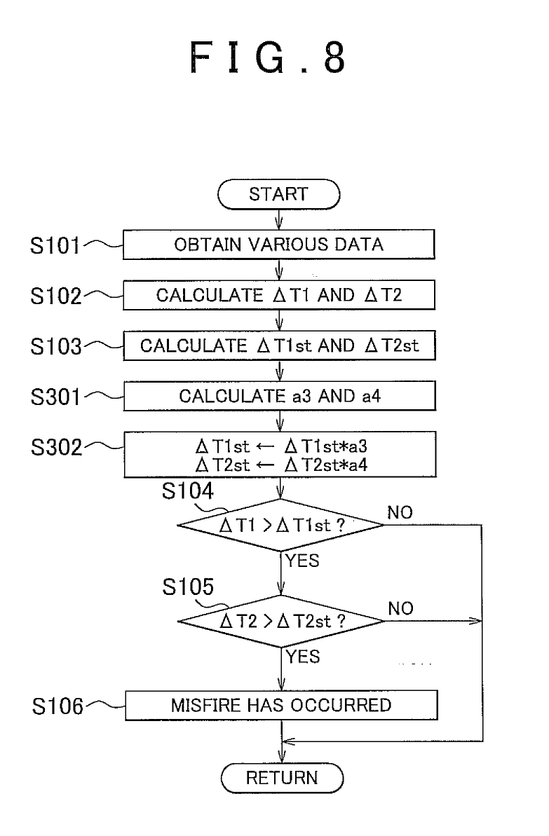

Next, a third example embodiment of the invention will be described with reference to FIGS. 7 and 8. Here, structure that differs from the structure of the first example embodiment described above will be described. Descriptions of like structure will be omitted.

The third example embodiment differs from the first example embodiment described above in that when a richening process that makes the target air-fuel ratio lower than a stoichiometric air-fuel ratio is executed, the determining values ΔT1st and ΔT2st are corrected according to the amount of decrease in the target air-fuel ratio.

When the richening process is being executed, the difference between the torque generated during a misfire and the torque generated during normal combustion is small. The difference at this time is smaller when the amount of decrease in the target air-fuel ratio is large than it is when the amount of decrease in the target air-fuel ratio is small. Therefore, the first determining value ΔT1st and the second determining value ΔT2st must be set to small values, and the relative difference between the first determining value ΔT1st and the second determining value ΔT2st must be increased, when the amount of decrease in the target air-fuel ratio is large compared with when the amount of decrease in the target air-fuel ratio is small.

Therefore, in a combustion state detection routine of the third example embodiment, the ECU 20 corrects the determining values ΔT1st and the ΔT2st based on the amount of decrease in the target air-fuel ratio. The correction amount at this time is determined such that the relative difference between the first determining value and the second determining value is larger when the amount of decrease in the target air-fuel ratio is large than it is when the amount of decrease in the target air-fuel ratio is small.

FIG. 7 is a map defining the relationship between the target air-fuel ratio and correction values a3 and a4 of the determining values ΔT1st and ΔT2st, respectively. The solid line in FIG. 7 represents a correction value (hereinafter referred to as the “third correction value”) a3 of the first determining value ΔT1st, and the alternate long and short dash line in FIG. 7 represents the correction value (hereinafter referred to as the “fourth correction value”) a4 of the second determining value ΔT2st.

In FIG. 7, the third correction value a3 and the fourth correction value a4 are set to 1 when the target air-fuel ratio matches the stoichiometric air-fuel ratio, and are set to positive numbers less than 1 when the target air-fuel ratio is lower than the stoichiometric air-fuel ratio. Furthermore, when the target air-fuel ratio is lower than the stoichiometric air-fuel ratio, the fourth correction value a4 is set to a smaller value than the third correction value a3 is. At this time, the relative difference between the third correction value a3 and the fourth correction value a4 is set to be greater when the target air-fuel ratio is low than it is when the target air-fuel ratio is high.

Next, the ECU 20 corrects the determining values ΔT1st and ΔT2st determined based on the required torque of the internal combustion engine 1 and the map in FIG. 3, with the correction values a3 and a4. More specifically, the ECU 20 multiplies the first determining value ΔT1st by the third correction value a3, and multiplies the second determining value ΔT2st by the fourth correction value a4.

Correcting the first determining value ΔT1st and the second determining value ΔT2st according to this kind of method enables a misfire to be more accurately detected even when a richening process is being executed.

Hereinafter, the procedure for executing the combustion state detection routine according to the third example embodiment will be described with reference to FIG. 8. FIG. 8 is a flowchart illustrating the combustion state detection routine. In FIG. 8, steps that are the same as those in the combustion state detection routine of the first example embodiment described above (see FIG. 4) will be denoted by the same step numbers.

This routine differs from the routine shown in FIG. 4 in that steps S301 and S302 are executed between steps S103 and S104. That is, the ECU 20 executes steps S301 and S302 after executing step S103.

In step S301, the ECU 20 calculates the third correction value a3 and the fourth correction value a4 based on a target air-fuel ratio and the map shown in FIG. 7. The target air-fuel ratio at this time may be calculated according to a target fuel injection quantity determined by the ECU 20 executing a separate fuel injection control routine and the output signal of the airflow meter 7 (i.e., the intake air amount), or the output signal of the air-fuel ratio sensor 9 may be used.

In step S302, the ECU 20 corrects the determining values ΔT1st and ΔT2st calculated in step S103, with the correction values a3 and a4 calculated in step S301. That is, the ECU 20 multiplies the first determining value ΔT1st by the third correction value a3, and multiplies the second determining value ΔT2st by the fourth correction value a4.

Steps S104 and S105 that follow are executed using the determining values ΔT1st and ΔT2st corrected in step S302.

According to the third example embodiment described above, a misfire can be more accurately determined (i.e., detected) even when a richening process is being executed, in addition to when the required torque of the internal combustion engine 1 is small. Incidentally, the third example embodiment may also be combined with the second example embodiment described above. Combining the third example embodiment with the second example embodiment make it possible to accurately determine (i.e., detect) that a misfire has occurred, when the required torque of the internal combustion engine 1 is small, when an ignition timing retarding process is being executed, and when a richening process is being executed.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A combustion state detection system for an internal combustion engine, comprising:
a calculating portion that calculates a one-step difference value and a two-step difference value of a physical quantity that correlates with torque generated by the internal combustion engine;
a detecting portion that detects that a misfire has occurred, when the one-step difference value calculated by the calculating portion is greater than a first determining value, and the two-step difference value calculated by the calculating portion is greater than a second determining value; and
a determining portion that determines the first determining value and the second determining value according to a required torque of the internal combustion engine, sensitivity of a change in the one-step difference value with respect to a change in the required torque, and sensitivity of a change in the two-step difference value with respect to a change in the required torque.

2. The combustion state detection system according to claim 1, wherein the determining portion determines the first determining value and the second determining value such that a relative difference between the first determining value and the second determining value increases as the required torque becomes smaller.

3. The combustion state detection system according to claim 1, wherein the determining portion determines the first determining value and the second determining value according to an ignition timing of the internal combustion engine, the sensitivity of the change in the one-step difference value with respect to a change in the ignition timing, and the sensitivity of the change in the two-step difference value with respect to a change in the ignition timing.

4. The combustion state detection system according to claim 3, wherein when an ignition timing retarding process that retards an ignition timing of the internal combustion engine beyond MBT is being executed, the determining portion determines the first determining value and the second determining value such that a relative difference between the first determining value and the second determining value increases as a retard amount of the ignition timing increases.

5. The combustion state detection system according to claim 1, wherein the determining portion determines the first determining value and the second determining value according to a target air-fuel ratio, the sensitivity of a change in the one-step difference value with respect to a change in the target air-fuel ratio, and the sensitivity of a change in the two-step difference value with respect to a change in the target air-fuel ratio.

6. The combustion state detection system according to claim 5, wherein when a richening process that makes a target air-fuel ratio lower than a stoichiometric air-fuel ratio is being executed, the determining portion determines the first determining value and the second determining value such that a relative difference between the first determining value and the second determining value increases as the target air-fuel ratio decreases.

7. The combustion state detection system according to claim 1, wherein the determining portion determines the first determining value and the second determining value based on a relationship in which a decrease rate at which the first determining value and the second determining value decrease becomes smaller as the required torque becomes smaller.

8. A combustion state detection method for an internal combustion engine, comprising:
calculating a one-step difference value and a two-step difference value of a physical quantity that correlates with torque generated by the internal combustion engine;
detecting that a misfire has occurred, when the calculated one-step difference value is greater than a first determining value, and the calculated two-step difference value is greater than a second determining value; and
determining the first determining value and the second determining value according to a required torque of the internal combustion engine, sensitivity of a change in the one-step difference value with respect to a change in the required torque, and sensitivity of a change in the two-step difference value with respect to a change in the required torque.

9. The combustion state detection method according to claim 8, wherein the first determining value and the second determining value are determined such that a relative difference between the first determining value and the second determining value increases as the required torque becomes smaller.

10. The combustion state detection method according to claim 8, wherein the first determining value and the second determining value are determined according to an ignition timing of the internal combustion engine, the sensitivity of the change in the one-step difference value with respect to a change in the ignition timing, and the sensitivity of the change in the two-step difference value with respect to a change in the ignition timing

11. The combustion state detection method according to claim 10, wherein when an ignition timing retarding process that retards an ignition timing of the internal combustion engine beyond MBT is being executed, the first determining value and the second determining value are determined such that a relative difference between the first determining value and the second determining value increases as a retard amount of the ignition timing increases.

12. The combustion state detection method according to claim 8, wherein the first determining value and the second determining value are determined according to a target air-fuel ratio, the sensitivity of a change in the one-step difference value with respect to a change in the target air-fuel ratio, and the sensitivity of a change in the two-step difference value with respect to a change in the target air-fuel ratio.

13. The combustion state detection method according to claim 12, wherein when a richening process that makes a target air-fuel ratio lower than a stoichiometric air-fuel ratio is being executed, the first determining value and the second determining value are determined such that a relative difference between the first determining value and the second determining value increases as the target air-fuel ratio decreases.

14. The combustion state detection method according to claim 8, wherein the first determining value and the second determining value are determined based on a relationship in which a decrease rate at which the first determining value and the second determining value decrease becomes smaller as the required torque becomes smaller.
